(19) United States
(12) Patent Application Publication
(10) Pub. No.: US 2008/0200239 A1
(43) Pub. Date: Aug. 21, 2008

(54) Gaming Machine with Non-Credit Based Outcomes

(76) Inventors: Jason C. Gilmore, Scottsdale, AZ (US); Roger C. Sharpe, Arlington Heights, IL (US)

Correspondence Address: NIXON PEABODY LLP, 161 N CLARK ST., 48TH FLOOR, CHICAGO, IL, 60601-3213, US

(21) Appl. No.: 11/883,064

(22) PCT Filed: Aug. 10, 2005
(86) PCT No.: PCT/US2005/028332

§ 371 Date: Jul. 26, 2007

Related U.S. Application Data
(60) Provisional application No. 60/652,460, filed on Feb. 11, 2005.

(51) Int. Cl. A63F 13/00; A63F 9/24

(52) U.S. Cl. 463/22; 463/27; 463/7

(57) ABSTRACT

A method of conducting a wagering game on a gaming machine comprises providing a representation of a passage of time, receiving a wager to play the wagering game, determining an outcome of the wagering game, the outcome being at least partially dependent upon the passage of time, and presenting an award, if any, based on the outcome.

### FIELD OF THE INVENTION

The present invention relates generally to gaming machines, and methods for playing wagering games, and more particularly, to a gaming machine having outcomes at least partially dependent upon time, scoring, or other non-credit based aspects of game play.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, gaming machine manufacturers continuously develop new games and improved gaming enhancements that will attract frequent play through enhanced entertainment value to the player.

One concept that has been successfully employed to enhance the entertainment value of a game is the concept of a “secondary” or “bonus” game that may be played in conjunction with a “basic” game. The bonus game may comprise any type of game, either similar to or completely different from the basic game, which is entered upon the occurrence of a selected event or outcome in the basic game. Generally, bonus games provide a greater expectation of winning than the basic game and may also be accompanied with more attractive or unusual video displays and/or audio. Bonus games may additionally award players with “progressive jackpot” awards that are funded, at least in part, by a percentage of coin-in from the gaming machine or a plurality of participating gaming machines. Because the bonus game concept offers tremendous advantages in player appeal and excitement relative to other known games, and because such games are attractive to both players and operators, there is a continuing need to develop gaming machines with new types of bonus games to satisfy the demands of players and operators.

Gaming machines have utilized a variety of mechanisms to present various combinations of symbols, and to award prizes, money, or other awards associated with certain predefined winning combinations. Traditional slot machines, for example, utilize a plurality of reels (either mechanical, or simulated on a video display) and at least one payline, with certain combination of symbols landing on the payline constituting winning combinations for which awards are given to the player in accordance with a pay table. Video poker gaming machines offer an alternative wherein winning combinations correspond with traditional winning poker hands.

Casinos and other gambling venues offer traditional table and machine games having a certain familiarity to those who frequent these establishments. Some players only play slot machines while others strictly play Blackjack or Roulette. Comfort and familiarity play a key role in attracting return players to game types and specific games. Repetitive play increases the player's knowledge of the game and, in turn, the speed at which the game is played. So it stands to reason that establishing familiarity and comfort benefits the player and the casino.

While familiarity and comfort with a particular game bodes well for the existing game types in a casino, the introduction of new games with different game play mechanics requires patience when attempting to determine the popularity because enough time must be allowed for the game to establish itself with the playing public. Certain features of an established game that are well known can be introduced into new games to increase the rapidity at which a player becomes familiar and comfortable with the new game. This form of attraction is historically successful to those who frequent gambling venues but attracting new patrons with games already familiar to them requires the introduction of games with play methods that may not be traditional in a casino.

To enhance the game offerings currently found in most casinos and attract a new type of patron, casinos should add new games that present many of the familiar play methods found in non-gambling type games.

### SUMMARY OF THE INVENTION

According to one aspect of the invention, a method of conducting a wagering game on a gaming machine comprises providing a representation of a passage of time, receiving a wager to play the wagering game, determining an outcome of the wagering game, the outcome being at least partially dependent upon the passage of time, and presenting an award, if any, based on the outcome.

According to another aspect of the invention, a method of conducting a wagering game on a gaming machine, the method comprises receiving a wager to play the wagering game, determining an outcome of the wagering game, the outcome being at least partially dependent upon a score, and presenting an award, if any, based on the outcome.

According to yet another aspect of the invention, a computer readable storage medium is encoded with instructions for directing a gaming device to perform the above methods.

An apparatus for conducting a wagering game is also disclosed herein.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a gaming machine embodying the present invention;

FIG. 2 is a block diagram of a control system suitable for operating the gaming machine;

FIGS. 3 and 4 are display images of a solitaire type card game in accordance with one embodiment of the present invention;

FIGS. 5 and 6 are display images of a array-based card game in accordance with a second embodiment of the present invention;

FIGS. 7 and 8 are display images of a twenty one type card game in accordance with a third embodiment of the present invention; and

FIGS. 9 and 10 are display images of a solitaire type card game in accordance with a fourth embodiment of the present invention.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

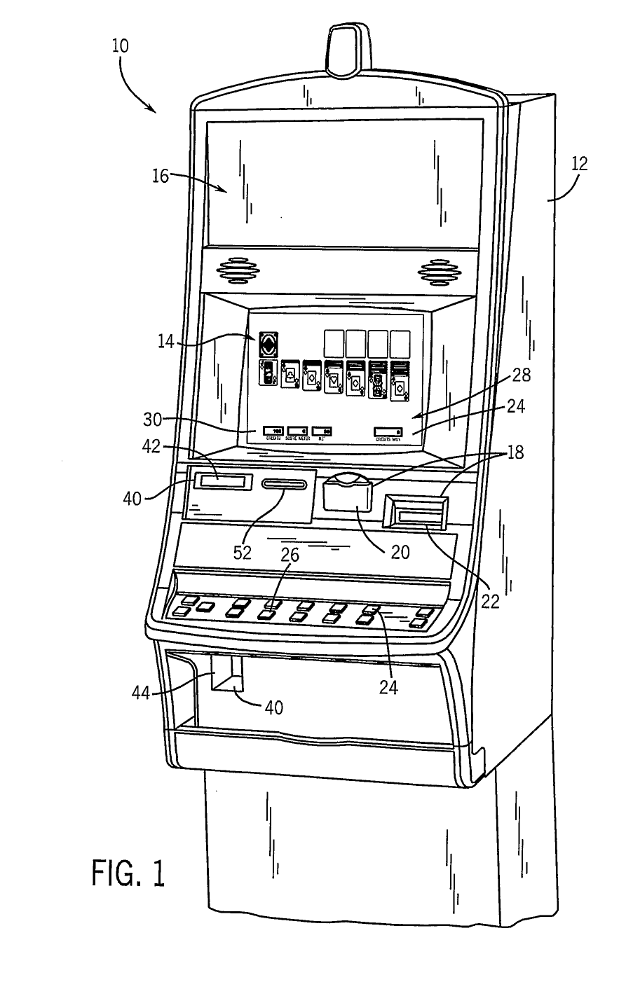

Referring to FIG. 1, a gaming machine 10 is used in gaming establishments such as casinos. With regard to the present invention, the gaming machine 10 may be any type of gaming machine and may have varying structures and methods of operation. For example, the gaming machine 10 may be an electromechanical gaming machine configured to play mechanical slots, or it may be an electronic gaming machine configured to play a video casino game, such as blackjack, slots, keno, poker, blackjack, roulette, etc.

The gaming machine 10 comprises a housing 12 and includes input devices, including a value input device 18 and a player input device 24. For output the gaming machine 10 includes a primary display 14 for displaying information about the basic wagering game. The primary display 14 can also display information about a bonus wagering game and a progressive wagering game. The gaming machine 10 may also include a secondary display 16 for displaying game events, game outcomes, and/or signage information. While these typical components found in the gaming machine 10 are described below, it should be understood that numerous other elements may exist and may be used in any number of combinations to create various forms of a gaming machine 10.

The value input device 18 may be provided in many forms, individually or in combination, and is preferably located on the front of the housing 12. The value input device 18 receives currency and/or credits that are inserted by a player. The value input device 18 may include a coin acceptor 20 for receiving coin currency (see FIG. 1). Alternatively, or in addition, the value input device 18 may include a bill acceptor 22 for receiving paper currency. Furthermore, the value input device 18 may include a ticket reader, or barcode scanner, for reading information stored on a credit ticket, a card, or other tangible portable credit storage device. The credit ticket or card may also authorize access to a central account, which can transfer money to the gaming machine 10.

The player input device 24 comprises a plurality of push buttons 26 on a button panel for operating the gaming machine 10. In addition, or alternatively, the player input device 24 may comprise a touch screen 28 mounted by adhesive, tape, or the like over the primary display 14 and/or secondary display 16. The touch screen 28 contains soft touch keys 30 denoted by graphics on the underlying primary display 14 and used to operate the gaming machine 10. The touch screen 28 provides players with an option on how to make their game selections. A player enables a desired function either by touching the touch screen 28 at an appropriate touch key 30 or by pressing an appropriate push button 26 on the button panel. The touch keys 30 may be used to implement the same functions as push buttons 26. Alternatively, the push buttons 26 may provide inputs for one aspect of the operating the game, while the touch keys 30 may allow for input needed for another aspect of the game.

The various components of the gaming machine 10 may be connected directly to, or contained within, the housing 12, as seen in FIG. 1, or may be located outboard of the housing 12 and connected to the housing 12 via a variety of different wired or wireless connection methods. Thus, the gaming machine 10 comprises these components whether housed in the housing 12, or outboard of the housing 12 and connected remotely.

The operation of the basic wagering game is displayed to the player on the primary display 14. The primary display 14 can also display the bonus game associated with the basic wagering game. The primary display 14 may take the form of a cathode ray tube (CRT), a high resolution LCD, a plasma display, an LED, or any other type of display suitable for use in the gaming machine 10. As shown, the primary display 14 includes the touch screen 28 overlaying the entire monitor (or a portion thereof) to allow players to make game-related selections. Alternatively, the primary display 14 of the gaming machine 10 may include a number of mechanical devices to display certain aspects of the game or the outcome resulting from a wager. In the illustrated embodiment, the gaming machine 10 is an “upright” version in which the primary display 14 is oriented vertically relative to the player. Alternatively, the gaming machine may be a “slant-top” version in which the primary display 14 is slanted at about a thirty-degree angle toward the player of the gaming machine 10.

A player begins play of the basic wagering game by making a wager via the value input device 18 of the gaming machine 10. A player can select play by using the player input device 24, via the buttons 26 or the touch screen keys 30. The basic game consists of a randomly mixed or shuffled set, array, stack, deck, or combination thereof of playing cards and any one or combination of a timer, placeholder, scoring meter, and other mechanisms used in play of the game. Outcomes are based on a combination of player skill and randomly generated presentations of playing cards.

In some embodiments, the gaming machine 10 may also include a player information reader 52 that allows for identification of a player by reading a card with information indicating his or her true identity. The player information reader 52 is shown in FIG. 1 as a card reader, but may take on many forms including a ticket reader, bar code scanner, RFID transceiver or computer readable storage medium interface. Currently, identification is generally used by casinos for rewarding certain players with complimentary services or special offers. For example, a player may be enrolled in the gaming establishment's loyalty club and may be awarded certain complimentary services as that player collects points in his or her player-tracking account. The player inserts his or her card into the player information reader 52, which allows the casino's computers to register that player's wagering at the gaming machine 10. The gaming machine 10 may use the secondary display 16 or other dedicated player-tracking display for providing the player with information about his or her account or other player-specific information. Also, in some embodiments, the information reader 52 may be used to restore game assets that the player achieved and saved during a previous game session.

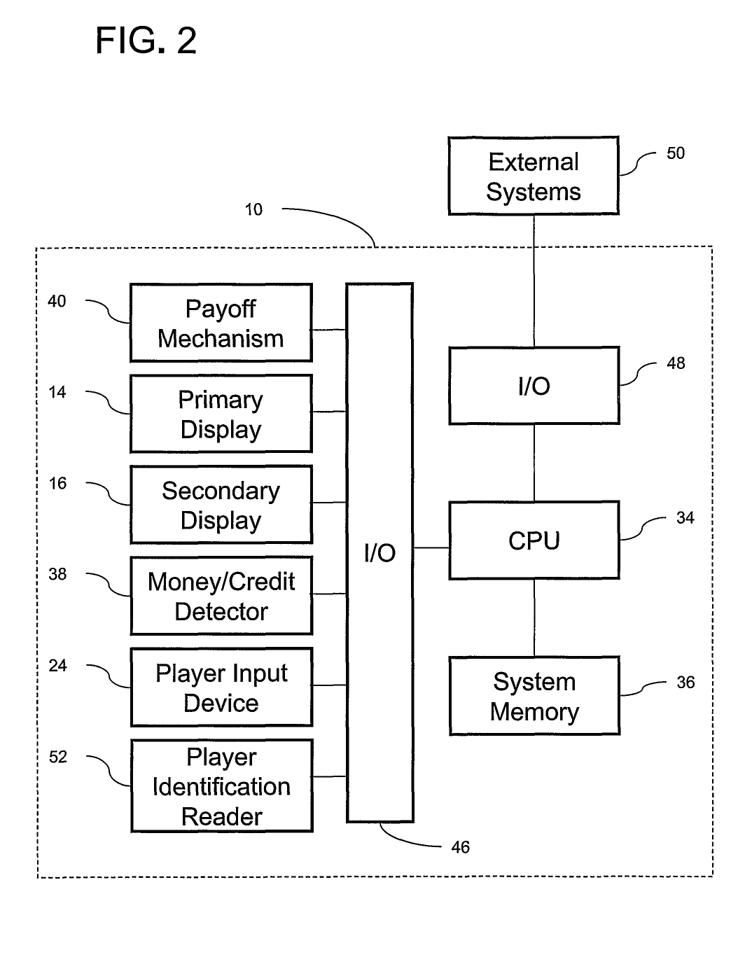

Turning now to FIG. 2, the various components of the gaming machine 10 are controlled by a central processing unit (CPU) 34, also referred to herein as a controller or processor (such as a microcontroller or microprocessor). To provide gaming functions, the controller 34 executes one or more game programs stored in a computer readable storage medium, in the form of memory 36. The controller 34 performs the random selection (using a random number generator (RNG)) of an outcome from the plurality of possible outcomes of the wagering game. Alternatively, the random event may be determined at a remote controller. The remote controller may use either an RNG or pooling scheme for its central determination of a game outcome. It should be appreciated that the controller 34 may include one or more microprocessors, including but not limited to a master processor, a slave processor, and a secondary or parallel processor.

The controller 34 is also coupled to the system memory 36 and a money/credit detector 38. The system memory 36 may comprise a volatile memory (e.g., a random-access memory (RAM)) and a non-volatile memory (e.g., an EEPROM). The system memory 36 may include multiple RAM and multiple program memories. The money/credit detector 38 signals the processor that money and/or credits have been input via the value input device 18. Preferably, these components are located within the housing 12 of the gaming machine 10. However, as explained above, these components may be located outboard of the housing 12 and connected to the remainder of the components of the gaming machine 10 via a variety of different wired or wireless connection methods.

As seen in FIG. 2, the controller 34 is also connected to, and controls, the primary display 14, the player input device 24, and a payoff mechanism 40. The payoff mechanism 40 is operable in response to instructions from the controller 34 to award a payoff to the player in response to certain winning outcomes that might occur in the basic game or the bonus game(s). The payoff may be provided in the form of points, bills, tickets, coupons, cards, etc. For example, in FIG. 1, the payoff mechanism 40 includes both a ticket printer 42 and a coin outlet 44. However, any of a variety of payoff mechanisms 40 well known in the art may be implemented, including cards, coins, tickets, smartcards, cash, etc. The payoff amounts distributed by the payoff mechanism 40 are determined by one or more pay tables stored in the system memory 36.

Communications between the controller 34 and both the peripheral components of the gaming machine 10 and external systems 50 occur through input/output (I/O) circuits 46, 48. More specifically, the controller 34 controls and receives inputs from the peripheral components of the gaming machine 10 through the input/output circuits 46. Further, the controller 34 communicates with the external systems 50 via the I/O circuits 48 and a communication path (e.g., serial, parallel, IR, RC, 10bT, etc.). The external systems 50 may include a gaming network, other gaming machines, a gaming server, communications hardware, or a variety of other interfaced systems or components. Although the I/O circuits 46, 48 may be shown as a single block, it should be appreciated that each of the I/O circuits 46, 48 may include a number of different types of I/O circuits.

Controller 34, as used herein, comprises any combination of hardware, software, and/or firmware that may be disposed or resident inside and/or outside of the gaming machine 10 that may communicate with and/or control the transfer of data between the gaming machine 10 and a bus, another computer, processor, or device and/or a service and/or a network. The controller 34 may comprise one or more controllers or processors. In FIG. 2, the controller 34 in the gaming machine 10 is depicted as comprising a CPU, but the controller 34 may alternatively comprises a CPU in combination with such couple components as the I/O circuits 46, 48 and the system memory 36.

The embodiments below present four different card games in which the outcome is at least partially dependent upon player skill and/or strategy and is at least partially dependent upon score, the passage of time, and/or clearing elements from part of the screen.

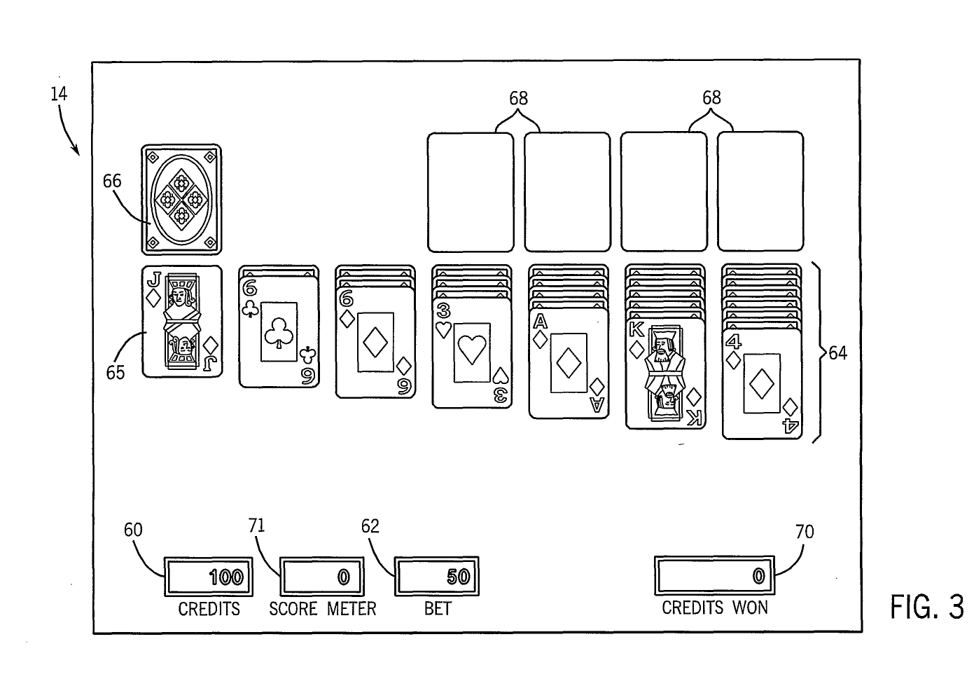

In accordance with a first embodiment of the present invention, FIG. 3 is a display image of a solitaire type card game presented on primary display 14. In this example, a player purchases a play of the game for a pre-specified amount of 50 credits as shown in Bet meter 62. As an alternative, a specified credit amount can be used to purchase multiple rounds that include multiple plays or variations thereof. Seven stacks of cards are then presented in an array 64. The cards are “dealt” randomly from a standard “deck” of fifty-two cards comprising thirteen cards from ace to king in four standard suits: clubs, spades, diamond, and hearts. Starting at the left-most stack 65, a single card dealt face up is presented. The second position shows a single card dealt face up and another single card underneath dealt face down. The third position shows a single card dealt face up and two cards dealt face down. This presentation of an additional face down card in each subsequent stack ends when the seventh position in card array 64 shows a single card face up and six cards face down. As will be noted by those with ordinary skill in the art, the arrangement and number of cards presented in the card array 64 is typical for a standard solitaire game but any combination of suits, cards, numbers, and visual icons can be used. The remaining twenty-four playing cards are positioned by the game in a deck 66 shown above the left-most stack 65. The main purpose of the game is to attempt to create four stacks (one stack per suit) in an ascending order starting with the aces. Alternatively, the stacks to be created can be predetermined by color or other common grouping. The scoring positions 68 are where the player creates the same-suit stacks. The player starts the game by placing any visible aces into the scoring positions 68. Any facedown card in array 64 may then be turned face up. The cards in the array 64 are played by creating descending stacks from king down to two in alternating color. For example, a red queen (either diamond or heart) may be moved from its present position onto a black king (either club or spade). Stacks containing multiple cards in this sequence may be played in their entirety as long as the highest card can be placed according to the color and sequence requirements. Any revealed down cards in the array 64 may be turned face up and played. Once all possible plays have been made on the array 64, a card or cards (depending on the rules of the game) may be selected from the deck 66, shown face up on a playing position 72, and played onto the stack or directly into one of the scoring positions 68, if possible. As an alternative, multiple playing positions may be presented such that two or three playing positions identical to playing position 72 are used to show two or three cards respectively. The display 14 also shows a Credits meter 60 displaying the total number of credits the player currently has, a Bet meter 62 showing the amount wagered to purchase the deck, a Score meter 71 showing the number of cards played to the scoring positions 68, and a Credits Won meter 70 showing the number of credits won during play of the game. Credits are won by multiplying the number in the Score meter 71 by a predetermined award per point.

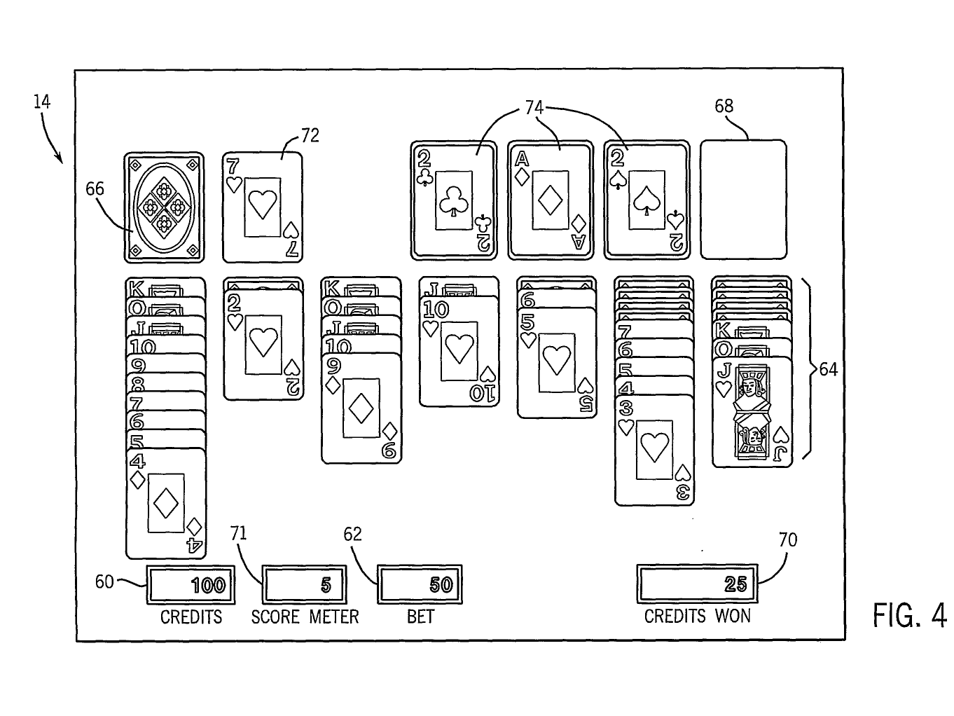

FIG. 4 is a display image from primary display 14 showing the game during play. Five cards 74 have been placed in the scoring position 68 (the ace of clubs and ace of spades are considered as being present below the two of clubs and two of spades, respectively) providing the player with five (5) points as shown in the Score meter 71 and 25 credits as shown in the Credit Won meter 70. This example assumes a multiplier of five credits for every point added to the Score meter 71. Another aspect of play of the game is when a position in the array 64 becomes open due to a player playing a last card or stack onto another leaving said position empty. Any individual king or sequential stack starting with a king may be moved to an empty position in the array 64. Note the sequential order of the cards in the stacks within the array 64 starting with the highest card and working down while alternating colors. Kings or sequential stacks starting with kings can be moved to stack locations that are void of cards. Alternatively, the starting card in any type of specified sequence can be predetermined and defined as the card allowed in empty stack locations. The stack starting with the kind on the far right may not be moved until another stack position becomes available. The game ends when all cards have been played into the scoring positions 68 or the last card in the deck 66 is turned and no further moves can be made. While the game awards credits when individual cards are placed into the scoring positions 68, a bonus can be awarded if all the cards have been played into the scoring positions 68. In this example, five credits are awarded for each card placed in the scoring positions 68 resulting in the five (5) shown in the Score meter 71 and 25 total shown in the Credits Won meter 70. If multiple rounds were purchased or if the game provides multiple rounds for a specified credit amount, awards or bonuses can be altered per round typically increasing as the rounds increase. Another alternative is the introduction of a timer to the game which may be used to limit the amount of time a player has to complete a round or game or to determine additional bonuses based on elapsed time. The timer can be any device that represents the passage of a predetermined or unlimited amount of time and includes, but is not limited to, a progress bar, sweep hand, LED array, digital clock, analog clock, or any graphical element with characteristics that allow it to be created or removed in a predetermined sequential order. Timers can be displayed or hidden. For example, a player could be informed by the game that they must complete a task within a specified amount of time. The game signals the player to begin then maintains the time internally. Players must then rely on their own ability to estimate the time remaining to accomplish the specified task. If multiple rounds are part of the game, rounds could become more difficult to complete if, in each subsequent round, less time or higher scores are required.

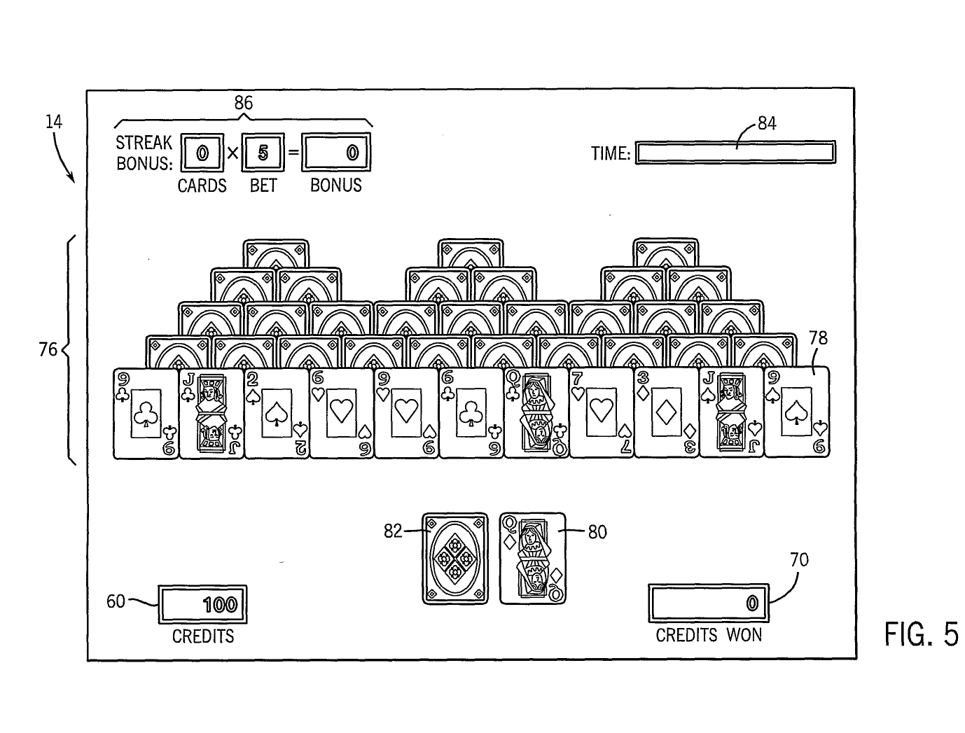

In accordance with another embodiment of the present invention, FIG. 5 is a display image of a array-based card game is presented on primary display 14. In this example, 39 cards are positions in array 76 in an overlapping fashion where the bottom row of face-up cards 78 overlaps the next row of face down cards. The object of the game is to remove or clear all the cards from the array 76. To play the game, a player purchases a play for a specified credit amount. As an alternative, a specific credit amount can be used to purchase multiple rounds that include multiple arrays or variations thereof. Once the array 76 and the first card from the deck 82 is displayed (playing position 80), the player must select a face up card from the array 76 that is sequentially adjacent to the card in the playing position 80. If the selected card from the array 76 is sequentially adjacent (higher or lower) to the card in the playing position 80, the game moves the selected card to the playing position 80. The next card selected from the array 76 must again be one higher or one lower than the card in the playing position 80 as long as it is sequentially adjacent to the value of the card. The player should determine the sequence in which the cards can most effectively be removed from the array 76 before they begin to move cards to maximize the number played during any one turn. To create a potentially continual sequence, aces are sequentially adjacent to kings and twos. In this example, the queen in the playing position 80 has been revealed and the player may select from one of two jacks shown on the face-up cards 78 in the array 76 because the jacks are the only two face-up cards that are sequentially adjacent to the queen. Once selected, the jack is moved to the playing position 80 on top of the queen and then the player continues moving sequentially adjacent cards from the face-up cards on the array 76 until no more sequentially adjacent cards are available. For this example, the player would remove a jack, then a queen, and then a jack. Once all moves are exhausted, the player draws from the deck 82. Credits are awarded for each card moved from the face-up cards in the array 76. A face down card in the array 76 is revealed when two adjacent face-up cards in the array 76 are removed during normal play of the game. A timer 84 is used to limit the amount of time a player has to complete a round or game or to determine additional bonuses based on elapsed time. The timer 84 can be any device that represents the passage of a predetermined or unlimited amount of time and includes, but is not limited to, a progress bar, sweep hand, LED array, digital clock, analog clock, or any graphical element with characteristics that allow it to be created or removed in a predetermined sequential order. The timer 84 can be displayed or hidden. For example, a player could be informed by the game that they must complete the game within a specified amount of time. The game signals the player to start then maintains the time internally. Players must then rely on their own ability to estimate the time remaining while attempting to accomplish the specified task of clearing the array 76. If multiple rounds are part of the game, rounds could become more difficult to complete if, in each subsequent round, less time is required. Additional awards can be presented for clearing an entire row of cards from the array 76. As an alternative, the array may be of other objects or symbols that can be matched or selected in a sequential order in keeping with the spirit of this embodiment. Another alternative is the use of wildcards to use in place of any card during the selection of a sequence of cards. Wildcards can be part of a basic game or may be offered for additional credits.

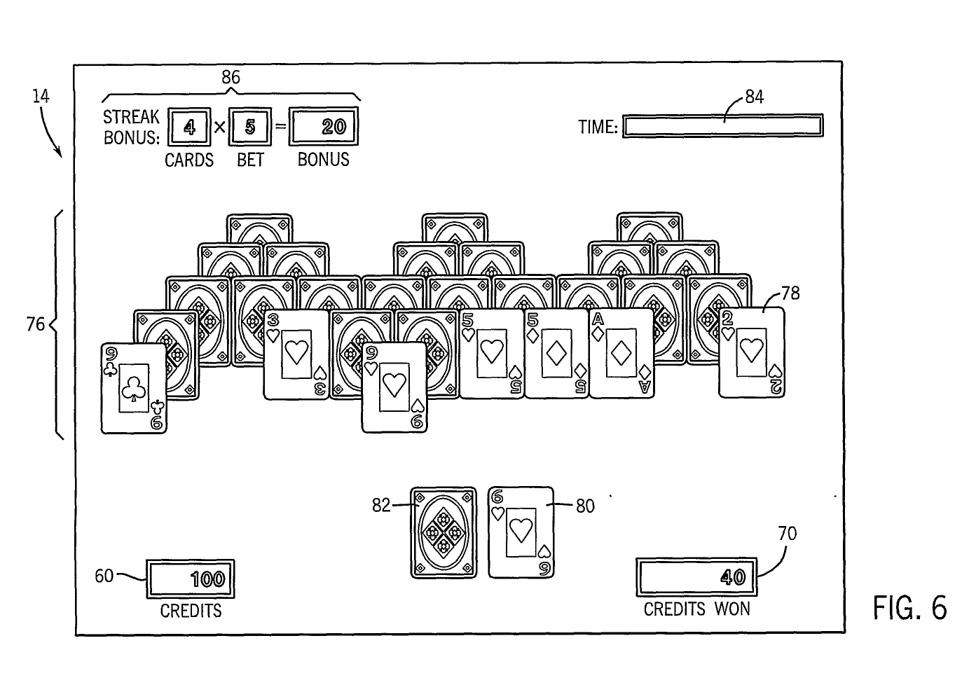

FIG. 6 is a display image from primary display 14 showing the array-based card game during play. The player has removed a number of cards from the array 76 and credits have been awarded in the Credits Won meter 70. A Streak Bonus meter 86 is displayed in the upper left corner of the display 14 showing the number of consecutive cards played (4) during the most successful turn the player has had and a multiplier used to calculate the bonus amount. In this example, twenty credits will be awarded if the streak of four cards remains as the highest streak amount at the end of the game. The game or round is complete when all cards have been cleared from the array 76. The game ends if no cards remain in the deck 82 and cards still remain in the array 76 or, in this example, the time displayed on the timer 84 has expired. As an alternative, the player may be given the option of ending the game before time expires to prevent the loss of a time bonus.

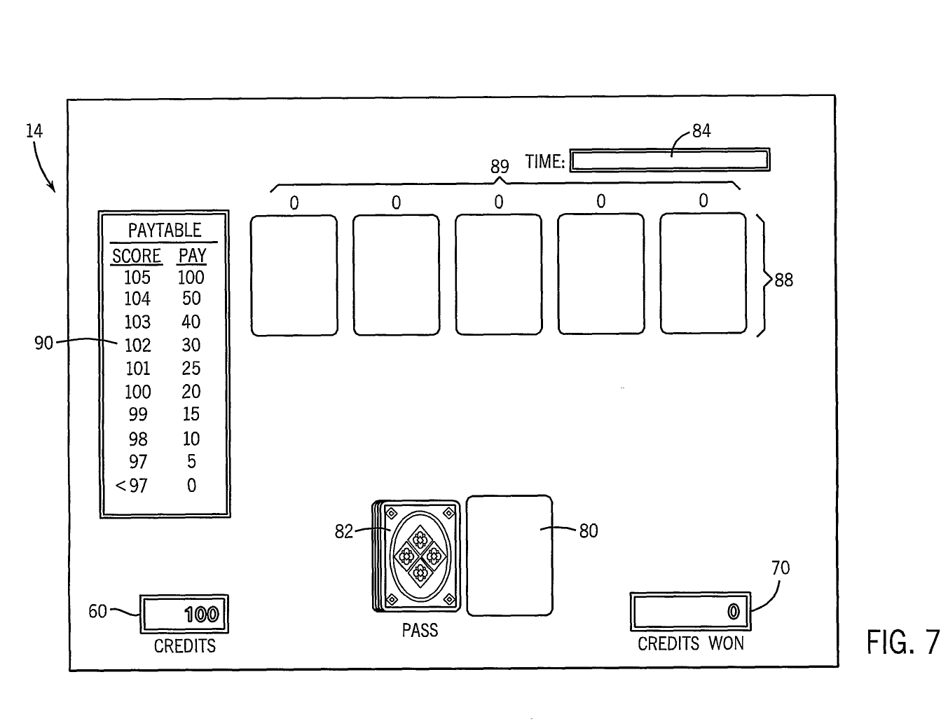

In yet another embodiment of the present invention, FIG. 7 presents a twenty one type card game on primary display 14. A player pays a specified credit amount to “purchase” the deck 82. Five card-hand positions 88 with point meters 89 are used by the player to stack cards drawn from the deck in the attempt to complete individual card hands with point values as close to, or totaling, twenty-one without exceeding twenty-one. The player “draws” a card from a deck 82. The newly drawn card is revealed in playing position 80. The player places the newly drawn card in any of the card-hand positions 88. This sequence continues until each position in the card-hand positions 88 contains cards with point values equaling, or as close as possible without exceeding, twenty-one. A timer 84 is used to force the player to act quickly adding an element of skill to the play of the game. The timer 84 can be any device that represents the passage of a predetermined or unlimited amount of time and includes, but is not limited to, a progress bar, sweep hand, LED array, digital clock, analog clock, or any graphical element with characteristics that allow it to be created or removed in a predetermined sequential order. The timer 84 can be displayed or hidden. For example, a player could be informed by the game that they must complete the game within a specified amount of time. The game signals the player to start then maintains the time internally. Players must then rely on their own ability to estimate the time remaining while attempting to accomplish the specified task of completing card sets equaling twenty-one. If multiple rounds are part of the game, rounds could become more difficult to complete if, in each subsequent round, less time is required. The card hands must be completed, or as close to completion as possible, before time expires. A pay table 90 is presented showing the player awards based on the total point count from the point meters 89 above the card-hand positions 88. The game is played in two rounds. One “pass” per round is granted which provides the player with the opportunity to pass or discard a drawn card instead of playing it onto one of the card-hand positions 88, if the player chooses. A bonus round is played if the sum of the point count from point meters 89 exceeds a specified total. For example, if the total points in the first two rounds of the game exceed 200, then a bonus round is started. Variations to the awards presented in the pay table for the base rounds, awards presented in the pay table 90 for the bonus round, the point threshold required to reach the bonus round, the number of passes allowed per round, the number of card hands to be played, and the amount of time per round will be recognized by those with ordinary skill in the art.

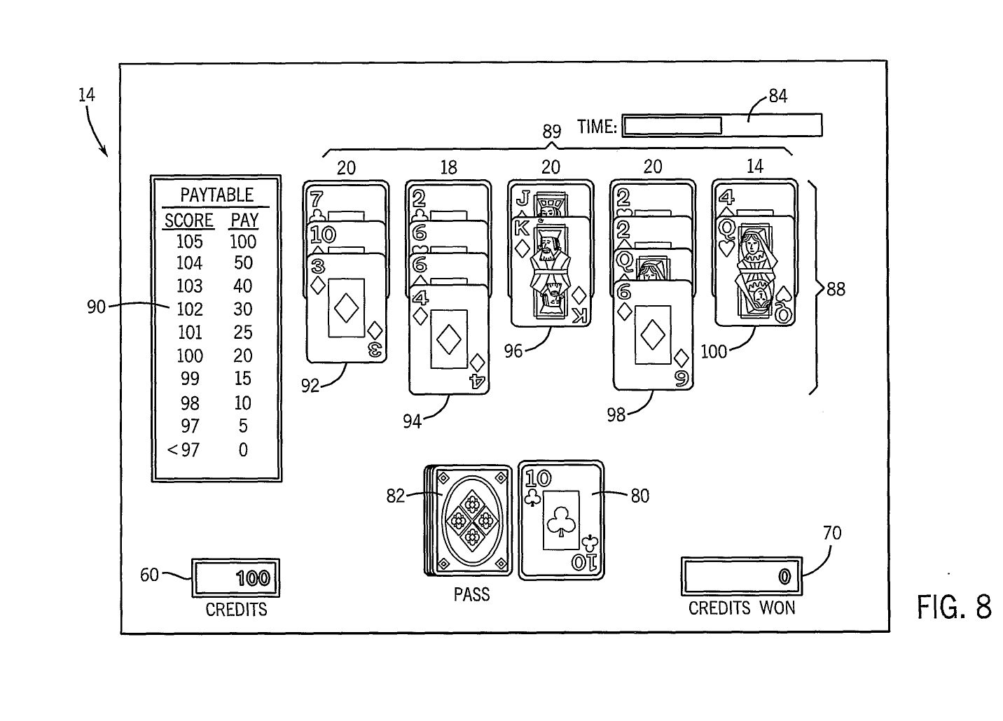

FIG. 8 is a display image from primary display 14 showing the twenty one type card game during play of the game. In this example, each card hand in the card-hand positions 88 has multiple cards with associated point value totals shown in the point meters 89. The player has placed these cards in these positions in an attempt to realize a total of twenty-one or come as close to twenty-one as possible in each respective card hand position without exceeding twenty-one. For example, the point value of the cards in the first card hand position 92 is twenty as shown by the point meter above this position. The point value on the point meter above the second card hand position 94 is eighteen. The third card hand position 96 shows a point value of twenty, as does the fourth card hand position 98. The fifth and last card hand position 100 shows a point value of 14. At this time, the card in the drawn card position 80 is a ten. The ten cannot be played on any of the card hand positions, as its point value will cause the point values in any of the card hand positions 88 to total more than twenty-one. At this point, the only option for the player is to pass or discard the ten in the drawn card position 80 in hopes of drawing a card from the deck 82 that may be added to one of the card hand positions 88 and create a total in that position equal or less than twenty-one. If the card that is drawn is again too high a value for any of the card hand positions 88, the game is over. The game also ends if the time on the timer 84 expires before all possible moves are completed. Alternatively, the game could end if a player attempts to play a card with too high a value on a card-hand position that would cause the point meter to exceed twenty-one. If this example was the end point of the game, the point value totals in the point meters are totaled and compared to the award values in the pay table 100. Because the total value of all point meters equals ninety-two and the lowest value associated with an award in the pay table 90 is ninety-seven, no award would be presented for this example. As another alternative, objects or icons with specified values can be used to create stacks totaling a predetermined number or value. Also, player could be given the option of ending a game at a particular point during the game to maximize their award based on the potential to lose the award because of time or if the player makes a mistake, such as exceeding the point limit on a hand. The player may also be given the opportunity to end play of the game if the next card played would exceed the point limit on any hand.

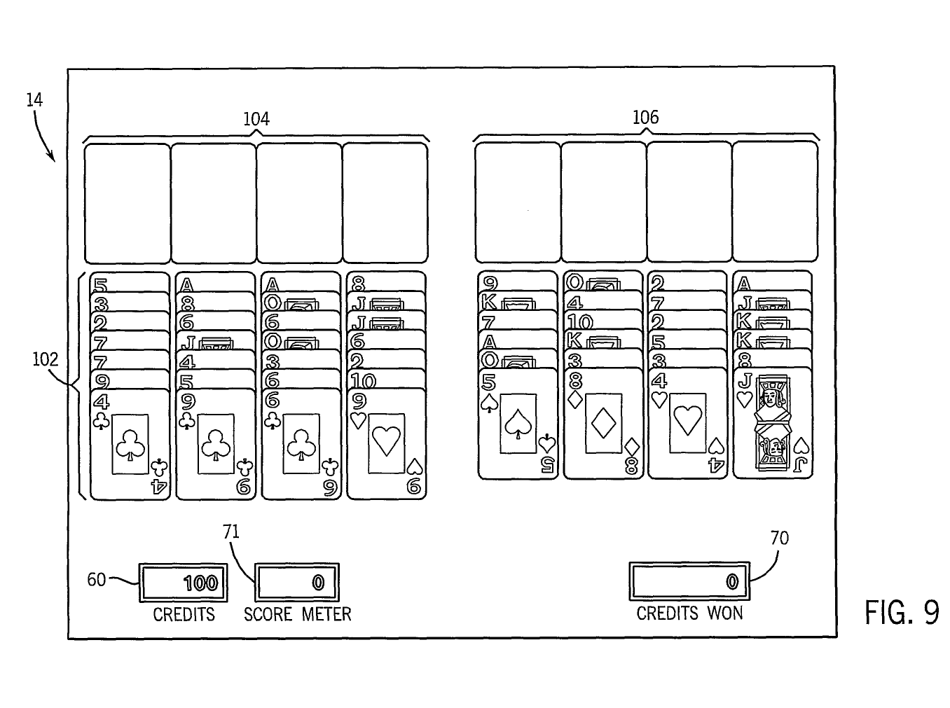

In accordance with yet another embodiment of the present invention, FIG. 9 presents a solitaire type card game on primary display 14. A player pays a specified credit amount to “purchase” a random array 102 of “dealt” cards. As an alternative, a specific credit amount can be used to purchase multiple rounds that include multiple arrays or variations thereof. The object of the game is to create stacks of cards from ace to king in the same suit in the home cells 106. The play of the game is performed by moving cards from stack to stack in the array 102 by placing individual cards in a sequentially descending order from king down to ace. In this embodiment, the cards in the sequential order must alternate in color between red and black. A run of cards, defined as two or more cards in a sequential order, may also be moved from one stack to another providing there is an appropriate amount of open spaces to move the cards. Placeholder cells 104 are used to temporarily hold cards moved from the array 102 to make room for other cards in a particular stack. Multiple cards may only be moved if there are positions available to support the number being moved in the placeholder cells 104, empty stack positions in the array 102, or a combination of the two. Points are scored when cards are added to the home cells 106. Points are displayed on Score meter 71. Awards are presented based on the number of points scored during play of the game. A bonus can be awarded for completing the game. As an alternative, a timer may be used to introduce another element of skill and award based on time. The timer can be any device that represents the passage of a predetermined or unlimited amount of time and includes, but is not limited to, a progress bar, sweep hand, LED array, digital clock, analog clock, or any graphical element with characteristics that allow it to be created or removed in a predetermined sequential order. The timer can be displayed or hidden. For example, a player could be informed by the game that they must complete the game within a specified amount of time. The game signals the player to start then maintains the time internally. Players must then rely on their own ability to estimate the time remaining while attempting to accomplish the specified task of creating same-suit stacks. If multiple rounds are part of the game, rounds could become more difficult to complete if, in each subsequent round, less time is required. Another alternative is to award bonuses for complete sequential stacks (king through ace) within the array 102

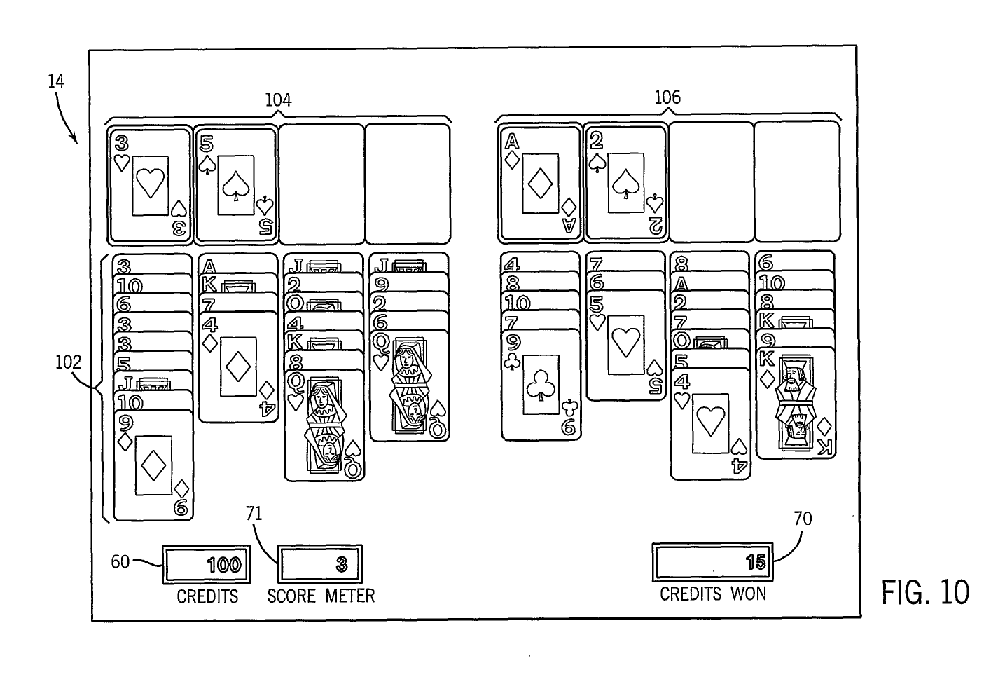

FIG. 10 is a display image from primary display 14 showing the solitaire type card game during play of the game. In this example, three cards have been placed in the home cells 106, thus presenting a current point total of three (3) in the Score meter 71. An award of 15 credits as shown in the Credits Won meter 70 is based on the point total in the Score meter 71. Two cards presently occupy the placeholder cells 104 leaving only two cells available to move other cards in the array 102.

While the present invention has been described with reference to one or more particular embodiments, those skilled in the art will recognize that many changes may be made thereto without departing from the spirit and scope of the present invention.

A variation to any of the game examples is the addition of a “wild” card or cards to the deck. Wild cards can be used to complete sets or can replace an existing card in the deck when played. An option to set the wild card aside and attempt to complete a game without it could result in a higher award payout or bonus. Multiple decks of cards can be used in any of the games presented. For example, the array-based card game in FIGS. 5 and 6 could present an array of cards much larger than the embodiment shown. In the solitaire type game in FIGS. 9 and 10, multiple home cells and placeholder cells can be used to offset a multiple deck array of dealt cards. While only some of the above embodiments show timers and use some form of time-based scoring or bonusing, all game examples contained herein may use timers as a primary, secondary, or bonus scoring mechanism. For example, the amount of time that a game can be played can be fixed so that the game is ended upon completion of the specified amount of time. Time can be used to award bonuses if the game is completed in a shortest amount of time or if a game is completed after a longest period of time. In this example, time is started at the beginning of play and runs continuously until the completion of the game or round. Awards can be based on the incremental amount of time remaining or the incremental amount of time used to complete a round, game, or task. For example, if 100 seconds is the time limit to complete a round in an array game shown in FIG. 6 and the player completes the round in 80 seconds, the remaining 20 seconds is awarded to the player in the form of points or credits. Multipliers can be applied to increase the point or award value. Using the 20-second example, if a multiplier of 2 is provided, then the points or award values would equal 40. A time range or ranges may be defined within a larger time span providing additional awards or points to players should they successfully perform specific tasks within the range or ranges. Using the twenty-one-type card game shown in FIG. 8 as an example, if a player completes a set equaling twenty-one during a specified range of time, additional awards, points, or bonuses can be provided. The range of time can be predetermined prior to the start of the game so that the player is aware of when they must focus their skill on completing a twenty-one set, or it could be a random event occurring during play without the player's knowledge of when it will occur. Thresholds may be defined within a larger period of time or continuous time and points or bonus can be awarded if players meet specified requirements prior to or upon reaching the specified threshold or thresholds. Time can be used strictly as a method of providing a bonus. As an example, if a player completes a game or a task before a specified amount of time expires, a bonus is awarded. If the specified amount of time expires before the game or task is completed, basic play of the game would continue without the bonus being awarded. Pay tables associated with time can be included in any of the card games using time as an additional feature. Using the 100 second time limit in an array game as an example, a pay table could be provided that defines ranges of time remaining or ranges of time used and associated awards for those ranges. Multiple pay tables based on multipliers can also be used for subsequent rounds where higher levels of skill are required to complete the round based on reduced time or higher scores required to reach the next round.

Each of these embodiments and obvious variations thereof is contemplated as falling within the spirit and scope of the claimed invention, which is set forth in the following claims.

1. A method of conducting a wagering game on a gaming machine, the method comprising:
providing a representation of a passage of time during the wagering game;
receiving a wager to play the wagering game;
determining an outcome of the wagering game, the outcome being at least partially dependent upon the passage of time; and
presenting a credits award, if any, based on the outcome of the wagering game, the award being indicated on a pay-table of the wagering game.

2. The method of claim 1, wherein the providing step includes providing a timer, bar, sweep hand, LED array, digital clock, analog clock, or a graphical element being created or removed in a sequential order.

3. The method of claim 1, further including starting the wagering game at a start time and terminating the wagering game at an end time, the representation of the passage of time representing the passage of time from the start time to the end time.

4. The method of claim 3, wherein the award includes a bonus if a player completes an objective of the wagering game before the end time.

5. The method of claim 4, wherein the wagering game includes a card game, and wherein the objective includes clearing a group of playing cards.

6. The method of claim 4, wherein the wagering game includes a card game, and wherein the objective includes scoring.

7. The method of claim 1, wherein the outcome is at least partially dependent upon skill or strategy.

8. The method of claim 1, wherein the outcome is at least partially dependent upon completion of the wagering game in a shortest time, a longest time, or before a certain amount of time has expired.

9. A method of conducting a wagering game on a gaming machine, the method comprising:
receiving a wager to play the wagering game;
determining an outcome of the wagering game, the outcome being at least partially dependent upon a score; and
presenting a monetary award, if any, based on the outcome of the wagering game, the monetary award being in the form of awarded credits.

10. The method of claim 9, further including displaying the score to a player.

11. The method of claim 9, wherein the wagering game includes a card game, and wherein the score is based upon accumulating playing cards of consecutive rank for each suit.

12. The method of claim 9, wherein the wagering game includes a card game, and wherein the score is based upon removing playing cards from a group, each removed card being associated with an active card outside the group.

13. The method of claim 9, wherein the wagering game includes a card game, and wherein the score is based upon point values of accumulated playing cards.

14. The method of claim 1, wherein the outcome is at least partially dependent upon skill or strategy.

15. An apparatus for conducting a wagering game, comprising:
a value input device for receiving a wager to play the wagering game;
a display for displaying a pay-table of the wagering game;
a controller operative to:
cause the display to provide a representation of a passage of time;
determine an outcome of the wagering game, the outcome being at least partially dependent upon the passage of time; and
provide an award, if any, based on the outcome of the wagering game, the award being in the form of credits indicated on the pay-table.

16. The apparatus of claim 15, wherein the representation includes a timer, bar, sweep hand, LED array, digital clock, analog clock, or a graphical element being created or removed in a sequential order.

17. The apparatus of claim 15, wherein the controller is operative to start the wagering game at a start time and terminate the wagering game at an end time, the representation of the passage of time representing the passage of time from the start time to the end time.

18. The apparatus of claim 17, wherein the award includes a bonus if a player completes an objective of the wagering game before the end time.

19. The apparatus of claim 15, wherein the outcome is at least partially dependent upon skill or strategy.

20. A computer readable storage medium encoded with instructions for directing a gaming device to perform the method of claim 1.

21. A computer readable storage medium encoded with instructions for directing a gaming device to perform the method of claim 9.
